(19) United States
(12) Patent Application Publication
(10) Pub. No.: US 2010/0115588 A1
(43) Pub. Date: May 6, 2010

(54) Prevent Unauthorised Subscriber Access Advertisement Service System

(75) Inventors: Hanna Johannesson, Stockholm (SE); Saswat Panigrahi, Montreal (CA); Emil Fengpei Zhang, Guangzhou (CN); Samuel Axelsson, Stocksund (SE)

Correspondence Address: ERICSSON INC., 6300 LEGACY DRIVE, M/S EVR 1-C-11, PLANO, TX, 75024, US

(73) Assignee: TELEFONAKTIEBOLAGET L M ERICSSON (PUBL), Stockholm (SE)

(21) Appl. No.: 12/532,910

(22) PCT Filed: Mar. 26, 2007
(86) PCT No.: PCT/SE2007/050183

§ 371 Date: Sep. 24, 2009

(51) Int. Cl. G06F 17/30; H04M 3/16

(52) U.S. Cl. 726/4; 455/410; 455/414.1

(57) ABSTRACT

The present invent ion relates to a mobile advertisement system (100), a method and an application server (40) used to prevent user equipments (10) hosting a forged client 5 application or client software to get access and to hold an external data network connection. According to the present invention, an application server (40) is adapted to receive from the core network (20) of the advertisement system (100) a message comprising an end user identification number (e.g. MSISDN). The application server is further configured to trigger an advertisement confirmation timer which expects to receive an advertisement display confirmation message from the client of the user equipment (10). Upon the timer expiring, the application server (40) request the core network (20) to disconnect the user equipment thereby preventing the user equipment hosting a forged client application to get access and to hold a external data network connection.

### TECHNICAL FIELD

The present invention relates generally to a mobile advertisement service system, and more particularly to a method, an application server and a system for preventing mobile users to bypass the mobile advertisement service system.

### BACKGROUND

With the continuous advances in mobile technologies such as the Global System for Mobile telecommunications (GSM) network, the General Packet Radio Service (GPRS) network, the Universal Mobile Telecommunication Systems (UMTS) network or third generation network (3G), the enhanced Data rates for GSM Evolution (EDGE) network, and the EDGE GPRS (EGPRS), and the WIMAX network, end users with mobile devices like PDAs and cellular phones are offered high speed mobile data services that enrich applications e.g. messaging (SMSm MMSm, IM), email, Internet browsers and also improve user experience. However, the data traffic fee for using these high speed data services is still relatively too high, which leads to a relatively small subscriber base. In a mobile or a cellular advertisement service system, network operators usually involve mobile advertisers in the mobile data services such that the revenue from the advertisers can reduce the traffic fee and bring more subscribers into the services. A subscriber to such mobile advertisement system usually downloads a client software/application or an advertisement program from an application server, to install it to his or her mobile communication device, so the advertisement(s) is/are exposed to the user on a main screen of the mobile device during, for example, network searching time and/or connection setup time. The subscribers can then start using mobile data services e.g. the Internet, at a relatively low data traffic fee.

Unfortunately, mobile users may install a forged client application or a forged advertisement program to his/her mobile device, to be able to use mobile data services without the advertisement(s) being rendered to the main screen of the mobile device. In other words, a non-subscriber to the mobile advertisement system or a “dishonest” subscriber using a forged client application may ignore the application server of the advertiser thereby bypassing the advertisement presentation but still holding e.g. an Internet connection, which severely damages the interest of the advertisers. The reason why a mobile user terminal or a user equipment hosting a forged client software application can bypass the advertisement presentation is that the authentication of the user equipment and the establishment of the network connection (e.g. the Internet connection) are usually handled by the core network (i.e. the network layer) of the mobile advertisement system, whereas the “client software-application server” communication is handled by the application server (i.e. the application layer or the service layer).

### SUMMARY

Accordingly, the present invention has been made to solve the above described problem occurring in an mobile advertisement service system, and it is an object of the present invention to provide a mobile advertisement system, an application server and a method of preventing mobile devices or user equipments hosting a forged client application from getting access to and holding an external data network connection (e.g. Internet) such that the interest of advertisers is not damaged.

According to a first aspect of the present invention, the above stated problem is solved by means of a mobile advertisement telecommunications system for preventing a user equipment hosting a forged client software/application, to get access and to hold an external data network connection (e.g the Internet). The mobile advertisement telecommunications system according to the present invention comprises: an application server that is adapted to receive from a core network of the mobile advertisement telecommunications system, a message comprising an end user identification number of the user equipment and to trigger an advertisement confirmation timer. The advertisement confirmation timer expects to receive an advertisement display confirmation message from the user equipment before the timer expires. The mobile advertisement system further comprises a core network (i.e. at the network layer) that is configured to receive from the application server (i.e at the application or service layer), a request to disconnect or detach the user equipment upon the advertisement timer expiring at the application server. The core network in cooperation with the application server therefore prevents the user equipment from getting access to and holding the external data network connection.

According to a second aspect of the present invention, the above stated problem is solved by means of a method of preventing a user equipment hosting a forged client application to get access to and to hold an external data access network (e.g. the Internet) connection, comprising the steps of: receiving at an application server, from a core network, a message comprising an end user identification number of the user equipment; triggering by the application server, an advertisement confirmation timer which is expecting to receive from the user equipment, an advertisement display confirmation message before the timer expires; and preventing the user equipment from getting access to and holding the network connection by requesting the core network to disconnect or detach the user equipment upon the advertisement timer expiring.

According to a third aspect of the present invention, the above stated problem is solved by means of an application server for preventing a user equipment with a forged client application to get access and to hold an external data network connection. The application server is configured to receive from a core network, a message comprising an end user identification number of the user equipment. Upon reception of the message, the application server is further configured to trigger an advertisement confirmation timer wherein the timer expects to receive an advertisement display confirmation message from the user equipment before the timer expires. The application server is, according to the present invention, further configured to request the core network, to disconnect or detach the user equipment upon the timer expiring in the application server, thereby preventing the user equipment hosting the forged client application to get access to and to hold the external data network connection.

In the present invention, because the application server at the application or service layer cooperates with the core network at the network layer, the probability that a user equipment, with a forged client application/software, bypasses the advertisement presentation/display on a main screen of the mobile device is eliminated.

An advantage with the present invention is that forged client applications used in the mobile advertisement system can be effectively detected and the users of such forged applications can be successfully prevented from illegally exploiting mobile advertisement systems and involved parties.

The present invention will now be described in more details by means of preferred embodiments and with reference to the accompanying drawings, attention to be called to the fact, however, that the following drawings are illustrative only, and that changes may be made in the specific embodiments illustrated and described within the scope of the appended claims.

### BRIEF DESCRIPTION OF THE DRAWINGS

FIG. 1 illustrates a simplified block diagram of a mobile advertisement system for advertisement bypass prevention, according to an exemplary embodiment of the present invention.

FIG. 2 illustrates signalling messages according to a use case for an exemplary embodiment of the present invention, wherein a user equipment is hosting a forged client application.

FIG. 3 illustrates signalling messages according to a use case for an exemplary embodiment of the present invention, wherein a user equipment is hosting a non-forged client application.

FIG. 4 illustrates 4A) a data structure of an Ad display confirmation message and 4B) a flow diagram relating to an Ad display confirmation message exchange.

FIG. 5 illustrates signalling messages according to a use case for another exemplary embodiment of the present invention, wherein a user equipment is hosting a forged client application.

FIG. 6 illustrates signalling messages according to a use case for another exemplary embodiment of the present invention, wherein a user equipment is hosting a non-forged client application.

FIG. 7 illustrates a flow diagram relating to a method according to the present invention.

FIG. 8 illustrates a block diagram of an exemplary embodiment of an application server according to the present invention.

### DETAILED DESCRIPTION

The invention is described in a general context in relation to a user equipment that houses hardware, drivers and firmware necessary to run a client application or software used to connect to a cellular network. The user equipment discussed throughout the description may be for example a laptop with a PC card, a mobile phone or any other type of device capable in connecting to an external data network (e.g. the Internet) via a cellular network.

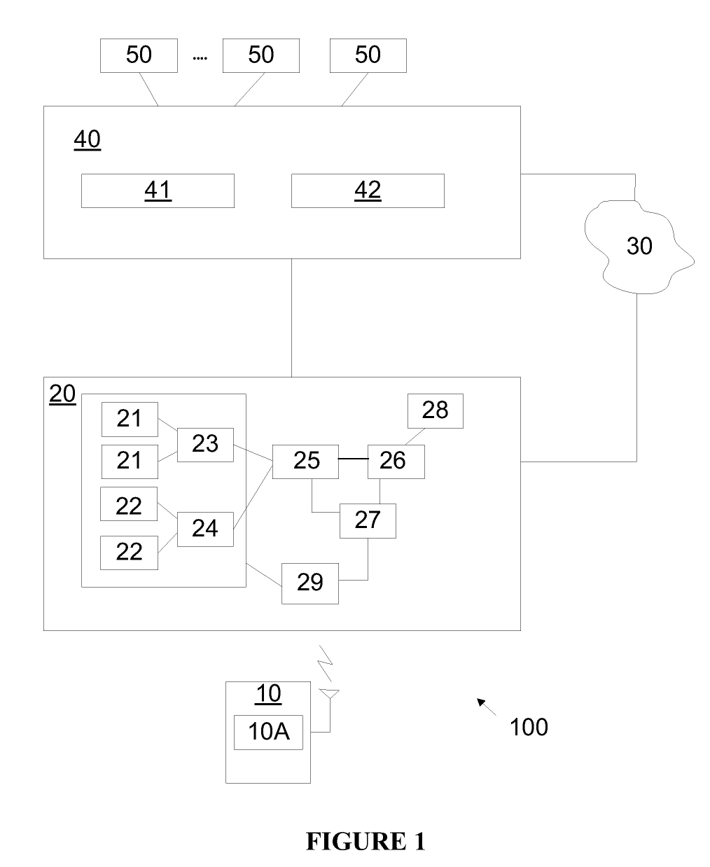

Referring to FIG. 1 there is illustrated a simplified block diagram of a mobile telecommunications advertisement system 100 for advertisement bypass prevention, according to an exemplary embodiment of the present invention. As shown in FIG. 1, one or several user equipments (mobile devices) 10 are configured to communicate with one or more networks and/or network elements of a core network 20. As illustrated, the core network (20) may include base transceiver stations (BTS) 21 that are connected to a base station controller (BSC) 23 and Node Bs 22 that are connected to a radio network controller (RNC) 24 of a cellular network. Node B is usually a term used in UMTS to denote a BTS. The core network 20 further includes a serving GPRS support node (SGSN) 25 that is connected to both a gateway GPRS support node (GGSN) 26 and to a home location register (HLR) 27. The core network 20 is further configured to communicate with an external data network 30 e.g. the Internet. The core network 20 further comprises other network nodes such as an AAA (Authentication, Authorization, and Accounting) server 28 and a mobile switching centre (MSC) and a visited location register (VLR) 29. An AAA server 28 is a server program that handles user requests for access to network resources and may further provide authentication, authorization, and accounting services. The AAA server 28 typically interacts with network access and gateway servers and with databases and directories containing user information. The current standard protocol by which devices or applications communicate with an AAA server is known as the Remote Authentication Dial-In User Service (RADIUS) protocol which is defined in IETF RFC 2865 (2000). The RADIUS protocol is thus a client/server protocol and software.

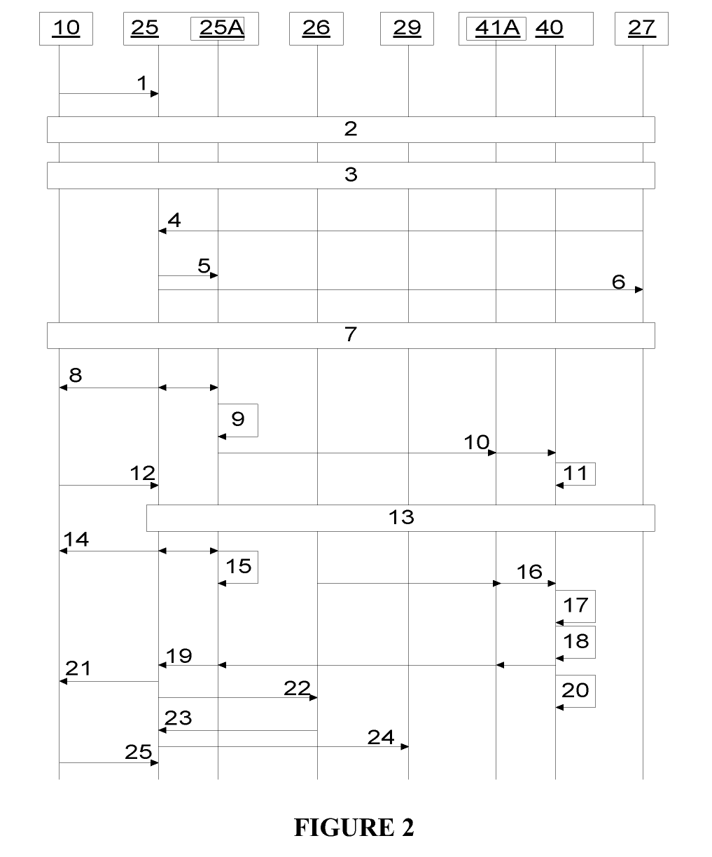

Also illustrated is an application server 40 operating in conjunction with the external data network 30 (e.g. the Internet). According to the present invention, the application server comprises a CAMEL (customized applications for mobile networks enhanced logic) interface 41 and a core network interface 42. The CAMEL is a known network feature to provide subscribers with operator specific services. Details on CAMEL are currently defined in 3GPP TS 2.078 V 7.2.0. The core network interface 42 is adapted to function as a RADIUS server to which, for example, the AAA server 28 may communicate. Furthermore and in accordance with an embodiment of the present invention, the application server 40 interfaces with one or several network nodes of the core network 20. Details on the network nodes that interface with the application server are illustrated and discussed in conjunction with subsequent FIGS. 2-3 and FIG. 5-6.

Referring back to FIG. 1, the application server 40 may be accessible to a plurality of advertisers 50. In the user equipment 10, a client application/software 10A has the capability to connect to a cellular network(s) which handles connection management, display of advertisements; download of advertisements from the application server and so on. It should be mentioned that UE 10 may download the client software 10A from the application server 40. As will be described, the application server 40 is, according to the present invention, adapted to receive from the core network 20 a message comprising an end user identification number of UE 10. The end user identification number may for example be a MSISDN (Mobile Subscriber Integrated Services Digital Network) number of the user equipment, a IMSI (International Mobile Subscriber Identity) number or any other number that can identify the user equipment 10. Upon reception of the message including the user identification number, the application server 40, according to the present invention, triggers an advertisement confirmation timer (Ad timer). Note that since the user equipment 10 already hosts a client software/application 10A, although forged, the core network 20 presumes that UE 10 is a subscriber of an advertisement service provided by an advertiser 50 or advertisers 50, as will be described in more details.

The Ad timer triggered in the application server 40 expects, according to the present invention, to receive an advertisement display confirmation message from UE 10 before it expires. The duration of the timer may for example be configured by e.g. an operator of the network or system 100. Upon the Ad timer expiring, the application server 40 requests, according to the present invention, the core network 20 to disconnect or detach UE 10 from the network thereby preventing UE 10 from getting access to the external data network 30 (e.g. the Internet).

Further embodiments of the present invention will now be described in more details based on an advertisement service system in which a GPRS cellular network is used to get access to an external data network, e.g. the Internet. Although, the present invention may also be used in other networks, such as a GSM network, a UMTS or third generation (3G) network, an EDGE network, a CDMA network or any other cellular or mobile network that can be used to get access to an external data network.

Referring to FIG. 2, there are illustrated signalling messages according to one use case for an exemplary embodiment of the present invention. It is here assumed that user equipment 10 is hosting a forged client application/software. As shown, in a first step 1, the user equipment 10 requesting a GPRS connection sends a “GPRS Attach Request” message to the SGSN 25 of the core network. The “GPRS Attach request” message comprises an end user identification number of UE 10. The user identification number may for example be the MSISDN number and/or the IMSI number. An equipment identity check (step 2) is subsequently performed between the HLR 27 and the SGSN 25 followed by a location update initiation (step 3) in case the serving SGSN 25 has changed. Steps 1-3 depicted in FIG. 2 are standard GPRS connection setup steps defined in 3GPP TS 23.060 V 6.11.0 (Release 6).

According to this embodiment, the HLR 27, in step 4, looks up the current user's subscription details and notices that UE 10 is a subscriber to an advertisement service (Ad service) provided by e.g. an advertiser. In this step 4, subscriber data are inserted by the HLR 27 into the SGSN 25 indicating to the SGSN 25 that UE 10 requires CAMEL support from the SGSN 25. In the subscriber data, a service code corresponding to an Ad service code is used by the SGSN 25 to determine which detection points (DP) to arm and also which CAMEL logic to invoke. The MAP (mobile application part) protocol is used to convey the subscriber data from the HLR 27 to the SGSN 25. The SGSN 25, upon receiving the subscriber data information from the HLR 27 activates in step 5 a GPRS service switching function (gprsSSF) 25A. In step 6, the SGSN 25 acknowledges the reception of subscriber data received at step 4 and in step 7 a location update complete is performed in case the SGSN 25 has changed. At step 8, a “GPRS Attach Accept” message is transmitted from the SGSN 25 to UE 10 informing UE 10 that it is now attached to the GPRS cellular/mobile network. Once the UE 10 is attached to the GPRS network, the detection point (DP) is triggered (or armed) in the SGSN 25 and a process is started in the gprsSSF 25A (step 9).

The process triggered in the gprsSSF 25A due to the GPRS Attach, sends, in step 10, a notification of successful attach along with the end user identification number (e.g. MSISDN) of UE 10 to a CAMEL component in the application server 41A. This component 41A is known as the GSM service control function (gsmSCF) and is part of CAMEL. The protocol used to transmit the notification of successful attach of UE 10 to the GPRS network is the CAMEL application part (CAP) protocol defined in 3GPP TS29.078 V7.3.0.

According to the present invention, the gsmSCF 41A relays (step 10) the notification information including the end user identification number (MSISDN) to the application server 40 using an internal protocol (depending on particular CAMEL service creation environment (SCE) in use). Note that the gsmSCF 41A is part of the application server.

The Application server 40 (step 11), upon being notified of a successful attach, initializes a waiting process, which expects to receive an Ad display confirmation message. In step 12-13, standard PDP context activation process steps are performed. When a PDP context accept is sent to UE 10 at step 14, the UE 10 has an internet protocol (IP) address and thus a usable external data network (e.g. Internet) connection. This makes it possible for the UE 10 to send an Ad display confirmation message to the application server. In step 15, the armed DP associated with the PDP context activation (which is common in CAMEL) triggers a process in the gprsSSF 25A of the SGSN 25. The process triggered in the gprsSSF 25A sends a notification (step 16), to the gsmSCF 41A using the CAP protocol, that the UE 10 has a usable Internet connection (IP address) established. The gsmSCF 41A relays this information to the application server 40.

According to the present invention, the application server 40, upon being notified of the usable connection (i.e. IP address) starts, in step 17, an Ad confirmation timer (Ad timer). The Ad timer (or the application server 40) expects to receive an Ad display confirmation message before the Ad timer expires. The expected Ad display confirmation message comprises, according to the present invention, the end user identification number (e.g. MSISDN) of UE 10.

It should be noted that the duration of the Ad timer, defining how long the application server 40 should wait for an Ad display confirmation message, may be configurable by e.g. an operator of the network or system 100.

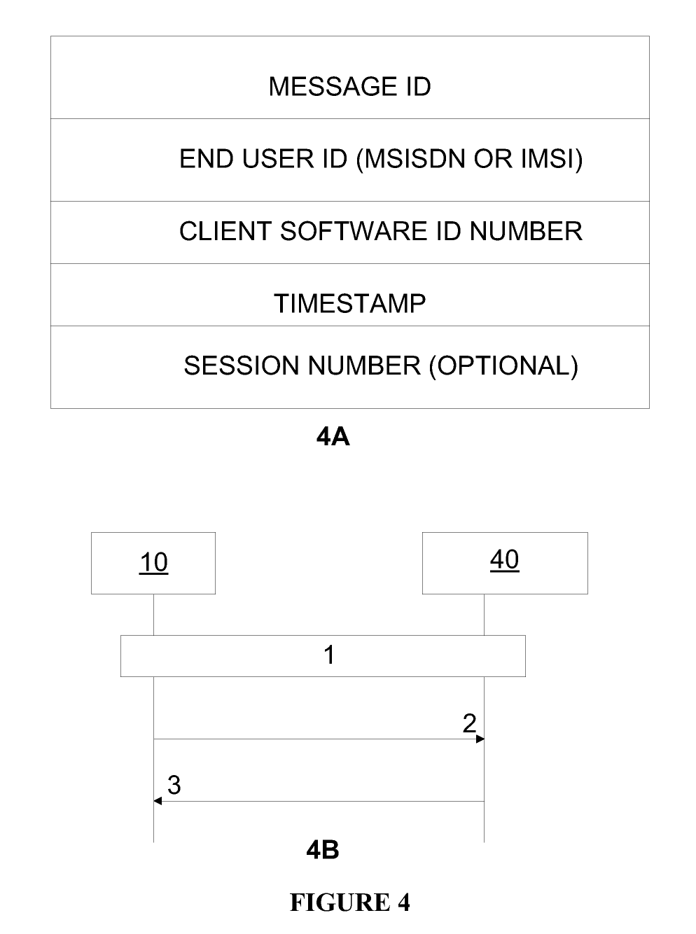

Since, as mentioned earlier, UE 10 is hosting a forged client application/software to connect to the external data network, a valid Ad display confirmation message is not received before the Ad timer expires. Thus, in step 18, the Ad timer expires. As will be described in conjunction with FIG. 4, a valid Ad display confirmation message implies, according to the present invention, that a message matches all the security criteria. In addition, the end user identification number (MSISDN) in the expected Ad display confirmation message must match the end user identification number received by the application server 40 from the SGSN 25. However, if no such valid Ad display confirmation message is received, the Ad timer keeps running and eventually expires.

Referring back to FIG. 2 and in accordance with the present invention, the application server 40, upon the Ad timer expiring, requests (step 19) the gsmSCF 41A to request a GPRS detach or GPRS disconnect of UE 10. This request is sent via gprsSSF 25A to the SGSN 25. Note that the gprsSSF 25A is a component or function in the SGSN 25A. The application server 40 may further keep a record (step 20) of the end user identification number (MSISDN) of UE 10 that will shortly be disconnected. The record may for example be used by the application server 40, the advertiser(s), or the core network for black-listing, charging or customer service purposes. Steps 21-25 correspond to the standard procedure for SGSN-initiated GPRS detach as defined in 3GPP TS.060 V6.11.0. After step 25, UE 10 hosting the forged client application/software is disconnected.

It should be noted that in the above described exemplary embodiment of the present invention, the GGSN 26 may, instead for the SGSN 25, comprise a component similar to the gprsSSF 25A which further interfaces with the application server 40. Thus, when the component in the GGSN 26 receives a create PDP context message from the SGSN 25, it could inform the application server 40 of a connection attempt by the user equipment. The application server may thereafter start the Ad timer and upon the expiring of the timer, it will request the GGSN 26 to disconnect the user equipment, i.e. to delete the PDP context. Then the GGSN starts a standard GPRS detach procedure.

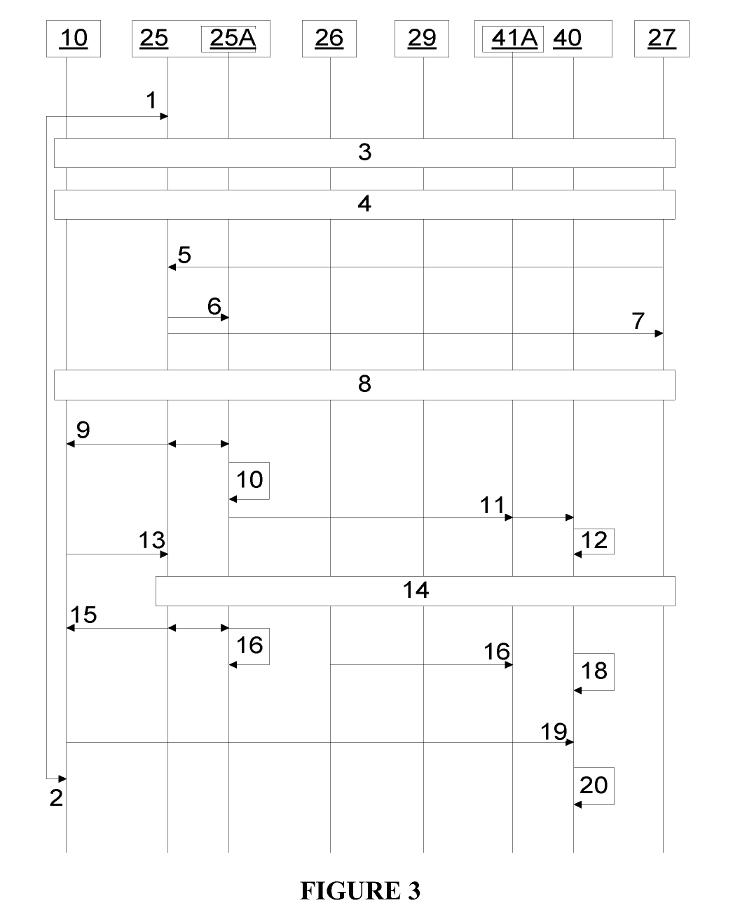

Referring to FIG. 3, there are illustrated signalling messages describing the case where the UE 10 is hosting a true client application/software, i.e. a non-forged client application/software. As shown in FIG. 3, in a first step 1, UE 10 requesting a GPRS connection sends a “GPRS Attach Request” message to the SGSN 25 of the core network. The “GPRS Attach request” message comprises the end user identification number of UE 10. In Step 2, an advertisement (Ad) is displayed on a main screen of UE 10. The Ad is displayed simultaneously with step 1 i.e. when a button or a key is pushed or clicked on UE 10 or in the graphical user interface (GUI) of the client application/software in UE 10. The Ad displayed continues while other connection setup steps proceed in parallel. Steps 3-4 are standard GPRS connection setups. In step 5, subscriber data are inserted by the HLR 27 into the SGSN 25 indicating to the SGSN 25 that UE 10 requires CAMEL support from the SGSN 25. In the subscriber data, a service code corresponding to an Ad service code is used by the SGSN 25 to determine which detection points (DP) to arm and also which CAMEL logic to invoke. The MAP (mobile application part) protocol is used to convey the subscriber data from the HLR 27 to the SGSN 25. The SGSN 25, upon receiving the subscriber data information from the HLR 27 activates in step 6 the GPRS service switching function (gprsSSF) 25A. Steps 7-9 are standard GPRS connection setup steps defined in 3GPP TS 23.060 V 6.11.0 (Release 6). In step 10, when “GPRS Attach Accept” message is sent to UE 10, UE 10 is now attached to the GPRS cellular network. Once UE 10 is attached to the GPRS network, the detection point (DP) is triggered (or armed) in the SGSN 25 and a process is started in the gprsSSF 25A (Step 10). Step 10 is similar to step 9 described in conjunction with FIG. 2. Steps 11-18 in FIG. 3 are similar to steps 10-17 illustrated in FIG. 2. In step 19, since UE 10 is hosting a true (or non-forged) client application/software, a valid Ad display confirmation message is received by the application server 40 from the client application in UE 10 before the Ad timer expires. This Ad display confirmation message thus confirms that the Ad has been displayed on the client in UE 10. In Step 20, as soon as the Ad display confirmation message is verified by the application server to be authentic, the Ad confirmation timer is disabled. Note that the Ad timer will not expire. The verification of the Ad display confirmation message is described with reference to FIG. 4. After Step 20, UE 10 has a normal GPRS cellular external data network session (Internet session).

FIG. 4 illustrates an example of a structure (see sub-FIG. 4A) of the Ad display confirmation message and illustrates (see sub-FIG. 4B) and discusses a method for the true (or non-forged) client application/software to securely confirm to the application server 40 that an Ad was displayed by the client in UE 10 during connection setup. Again, if the Ad is not displayed in the client, the application server 40 will start, as described before, the process of closing the connection after waiting for the expiration of the Ad timer. In order that the Ad confirmation message securely matches all the security criteria, it is according to the present invention a prerequisite that the client application in UE 10 and the application server 40 negotiate to use a symmetric encryption algorithm to communicate with each other, for example, AES (advanced encryption standard) as defined in “AES, Federal Information Processing Standards, Publication 197 (November 2001)”. In order to exchange e.g. a AES key, a key exchange algorithm is used, for example, Diffie-Hellman defined in “Diffie-Hellman Key-agreement Standard, An RSA Laboratories Technical Note, Version 1.4 (November 1993).

Note that the encryption algorithm and the key exchange algorithm discussed above are only examples of algorithms that may be used and the present invention is therefore not restricted to any particular algorithm(s).

Sub-FIG. 4B illustrates an Ad display confirmation message exchange between the client in UE 10 and the application server 40.

In step 1, the client in UE 10 and the application server 40 generate a key using e.g. the Diffie-Hellman algorithm. In step 2, the client in UE 10 sends to the application server 40 an Ad display confirmation message encrypted using the generated key. This message includes an end user identification number of UE 10 (e.g. MSISDN or IMSI). Finally, in step 3, the application server 40 sends back an acknowledgment encrypted using the same key generated in step 1.

The structure of the Ad display confirmation message, prior to any encryption, can for example have the structure depicted in sub-FIG. 4A. As clearly indicated in sub-FIG. 4A, a session number which refers to the session for communication between client and application server for Ad display conformation message and its acknowledgement, is optional. It should also be mentioned that the session for communication between the client and the application server is a special session that needs to be secure. Future sessions between the client and the application server e.g. while downloading an Ad URL or the media itself are not necessarily secure. The operator of the network may however, by design, decide to secure all communications between the client and the application server. As illustrated in sub-FIG. 4A, the structure of the Ad display confirmation message may further include a client software/application identification number, a message identification (ID) and a timestamp.

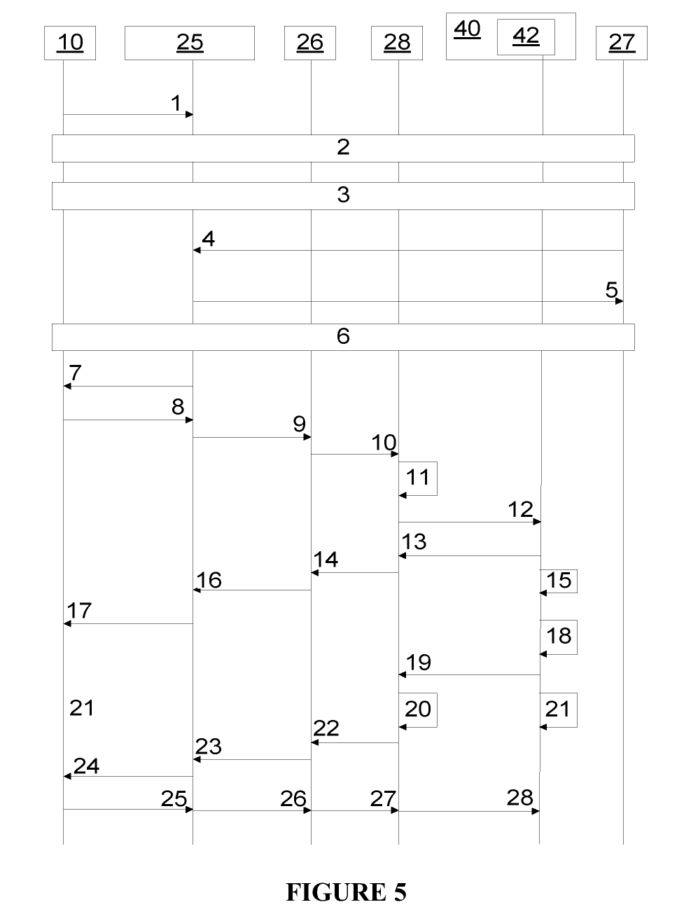

Referring to FIG. 5, there are illustrated signalling messages according to use case for another exemplary embodiment of the present invention. It is here also assumed that the user equipment is hosting a forged client application/software. In this exemplary embodiment, standard GPRS connection setup steps are illustrated but their description is omitted. The standard GPRS connection setup steps, as defined in 3GPP TS 23.060 V 6.11.0 (Release 6) corresponds to steps 1-8. In step 9, a “Create PDP Context” is transmitted from the SGSN 25 to the GGSN 26. Upon the GGSN 26 receiving the “Create PDP Context”, a RADIUS client (not illustrated) in the GGSN 26 sends (step 10) an “Access Request” message to a RADIUS server (not illustrated) in the AAA server 28. In this message is included the end user identification number of UE 10 (e.g. MSISDN) received from the SGSN 25. From the end user identification number sent as part of the “Access Request” message, the AAA server 28 looks up (step 11) from its database (e.g. a policy database) and notices that UE 10 is a subscriber to an Ad service. In step 12, the AAA server 28, upon noticing that UE 10 is a subscriber to the Ad service, forwards the “Access Request” message to a RADIUS server (not illustrated) in the core network interface 42 of the application server 40. The RADIUS server in the application server 40 then checks using the end user identification number, if the subscriber (or UE 10) is black-listed from previous attempts to get access to the external data network using a forged client application/software. Assuming that UE 10 (or the subscriber) is not black-listed, the core network interface 42 (or the RADIUS server), in step 13, sends an “Access Accept” message to the AAA server 28. The AAA server 28 then forwards, in step 14, the “Access Accept” message to the RADIUS client in the GGSN 26, along with an allocated IP address for UE 10. It should be noted that this “Access Accept” message is not necessarily conditional on the “Access Accept” message from the RADIUS server of the core network interface 42 in the application server 40. Depending on configuration capabilities of the AAA server 28 in use, step 14, does not have to wait for an “Access Accept” message in step 13 from the RADIUS server of the core network interface 42. Thus, according to the present embodiment, steps 12-13 are used to notify the application server 40 of the end user identification number and of the new connection (i.e. the “Access Request” message). In step 15, the application server 40, upon being notified of the end user identification number and of the new connection, triggers an Ad confirmation timer (Ad timer). The application server 40 (or the Ad timer) expects, according to the present invention, an Ad display confirmation message (along with the end user identification number) before the Ad timer expires. Similarly to the previous embodiment of the present invention, the duration of the Ad timer, defining how long the application server 40 should wait for an Ad display confirmation message before concluding that the client application is a forged application, may be configurable by, for example, the operator of the network. Following step 15, standard GPRS connection setup steps 16-17 are performed which correspond to a PDP context activation process.

Following step 17 (i.e. a PDP context accept), UE 10 has a usable Internet (or external data network) connection. Since UE 10 is hosting a forged client application/software, a valid Ad display confirmation message is not received before the Ad timer expires. As mentioned in the previous exemplary embodiment of the present invention, a valid Ad display confirmation message implies that the message matches all the security criteria as described above in conjunction with FIG. 4. In addition, the end user identification number (MSISDN) in the expected Ad display confirmation message must match the end user identification number received by the application server 40 from the SGSN 25. However, if no such valid Ad display confirmation message is received, the Ad timer keeps running and eventually expires. Upon the Ad timer expiring in step 18, the application server 40 concludes that UE 10 is hosting a forged client application/software and that the advertisement has not been displayed on UE 10. The application server 40 then sends in this step 19, a “RADIUS Disconnect Request” message to the AAA server 28. It should be noted that a “RADIUS Disconnect Request” message is defined in IETF RFC 2882 (2000): “Network Access Server Requirements: Extended RADIUS Practices”.

Upon receiving the “RADIUS Disconnect Request” message from the application server 40, the AAA server 28, in step 20, may again verify if UE 10 is a subscriber to the Ad service in order to validate that the application server 40 has the authority to send a Disconnect Request. In step 21, the application server 40 may maintain a record of the user identification number (MSISDN) of UE 10 who will shortly be disconnected from the network. Similarly to the previous embodiment of the present invention, the record may be used for black-listing, charging or for customer service purposes. Finally, a standard procedure for AAA-initiated PDP Context Deactivation as defined in “Gi Interface Description, 1/1551-AXB 250 10/2 Uen, Rev. A”, is performed in steps 22-28. Thereafter, UE 10 hosting a forged client application has been disconnected.

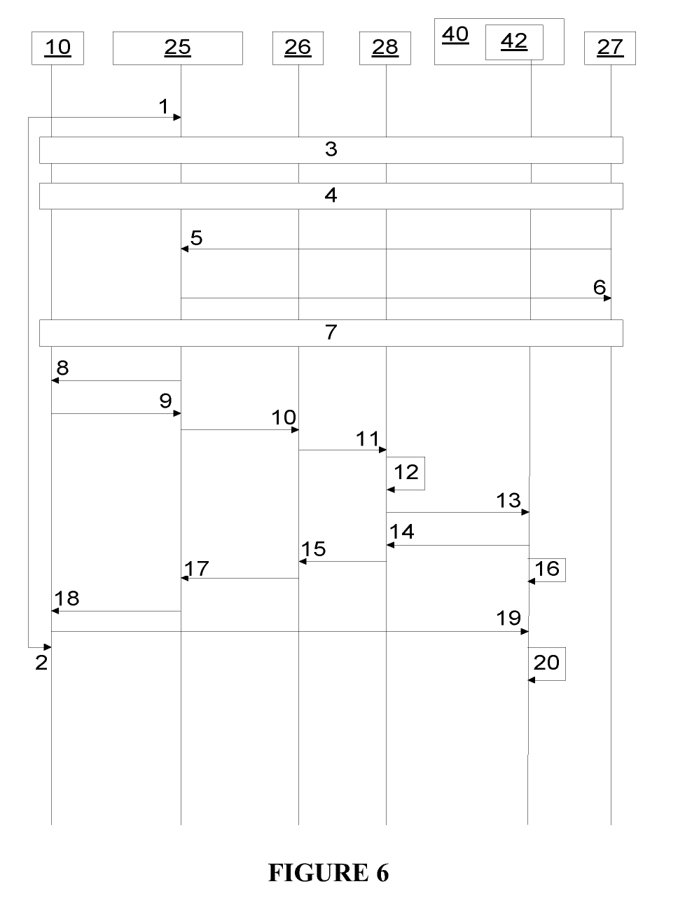

Referring to FIG. 6, there are illustrated signalling messages describing the case where UE 10 is hosting a true (non-forged) client application/software with respect to the second exemplary embodiment described in conjunction with FIG. 5. As shown in FIG. 6, following standard GPRS connection setup step 1 (i.e “GPRS Attach Request”), an Ad display begins (step 2) on UE 10 simultaneously with step 1 when, for example, a connect button in UE GUI is clicked or pushed. The Ad display continues while other connection setup steps proceed in parallel. Steps 3-10 corresponds to standard GPRS connection setup steps as defined in 3GPP TS 23.060 V6.11.0 (Release 6). Upon receiving from the SGSN 25, in step 10, the “Create PDP Context Request” along with the end user identification number of UE 10 (MSISDN), the RADIUS client in the GGSN 26 sends in step 11, an “Access Request” message to a RADIUS server in the AAA server 28. This message includes the end user identification number of UE 10 (i.e. MSISDN) received from the SGSN 25. From the end user identification number sent as part of the “Access Request” message, the AAA server 28 looks up (step 12) from its database (e.g. a policy database) and finds that UE 10 is a subscriber to an Ad service. In step 13, the AAA server 28, upon noticing that UE 10 is a subscriber to the Ad service, forwards the “Access Request” message to the RADIUS server in the core network interface 42 of the application server 40. The RADIUS server in the application server 40 further checks in step 14, using the end user identification number, if the subscriber (or UE 10) is black-listed from previous attempts to get access to the external data network using a forged client application/software. In this case scenario, UE 10 is not black-listed since the client application/software in UE 10 is not forged. The core network interface 42 (or RADIUS server) in the application server 40 then sends, in step 14, an “Access Accept” message to the AAA server 28. The AAA server 28 forwards, in step 15, the “Access Accept” message to the RADIUS client in the GGSN 26 along with an allocated IP address for UE 10. It should be noted that this “Access Accept” message is not necessarily conditional on the “Access Accept” message from the RADIUS server of the core network interface 42 in the application server 40. Depending on configuration capabilities of the AAA server 28 in use, step 15, does not have to wait for an “Access Accept” message in step 14 from the RADIUS server of the core network interface 42. Thus, according to the present embodiment, steps 13-14 are used to notify the application server 40 of the end user identification number and of the new connection (i.e. the “Access Request” message). In step 16, the application server 40, upon being notified of the end user identification number (MSISDN) and of the new connection, triggers an Ad confirmation timer (Ad timer). The application server 40 (or the Ad timer) expects, according to the present invention, an Ad display confirmation message (along with the end user identification number) before the Ad timer expires. Similarly to the previously described embodiments of the present invention, the duration of the Ad timer, defining how long the application server 40 should wait for an Ad display confirmation message before concluding that the client application is a forged application, may be configurable by, for example, the operator of the network. Following step 16, standard GPRS connection setup steps 17-18 are performed which correspond to a PDP context activation process.

Following step 18 (i.e. a PDP context accept), UE 10 has a usable Internet (or external data network) connection. In step 19, a valid Ad display confirmation message is received by the application server 40 from the client application/software in UE 10, before the Ad timer expires. This message confirms that the Ad has been displayed on the client. The structure of the Ad confirmation message has already been illustrated in FIG. 4 and also described earlier. In step 20, the application server 40 disables the Ad confirmation timer as soon as the Ad display message is verified by the application server 40 to be authentic. Note that in this scenario, the Ad timer will not expire. Following step 20, UE 10 which hosts a true (non-forged) client application/software has a normal cellular Internet session (or external data network session).

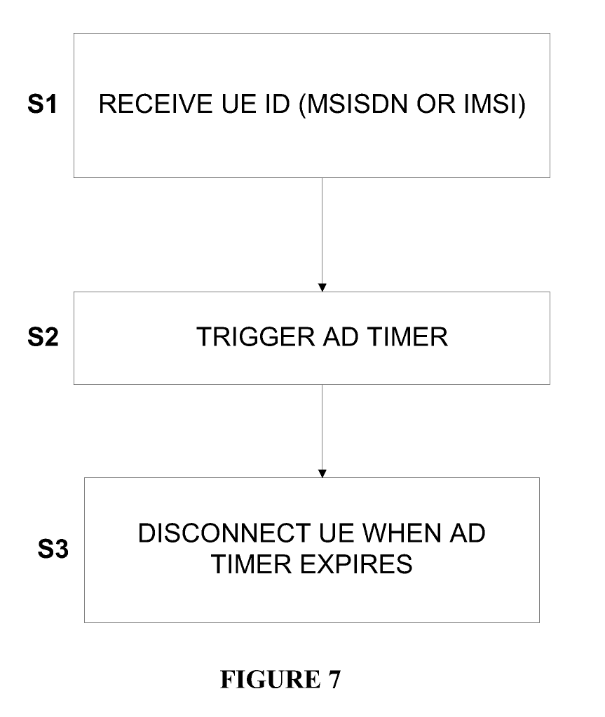

Referring to FIG. 7, there is illustrated a method describing how a user equipment hosting a forged client application is detected and prevented from getting access to an external data network connected (e.g. the Internet).

In a first step (S1), a message comprising an end user identification number of a user equipment (MSISDN or IMSI) is received by an application server from a core network. In step 2 (S2), an advertisement confirmation timer (Ad timer) is triggered at the application server, wherein the Ad timer is expecting to receive an advertisement display confirmation message from the client application on the user equipment before the Ad timer expires. In step 3 (S3), the user equipment is prevented from getting access to the external data network connection (e.g. the Internet) by sending from the application server to the core network, a request to disconnect the user equipment upon the Ad timer expiring.

The application server, upon determining that the Ad timer has expired may store a record of the end user identification number. As mentioned earlier, the advertisement display confirmation message that is expected by the application server comprises, according to the present invention, the end user identification number of the user equipment (e.g. MSISDN or IMSI) that is hosting an authentic/true client application/software and a unique identification of the advertisement display confirmation message (i.e. Message ID) as illustrated in FIG. 4.

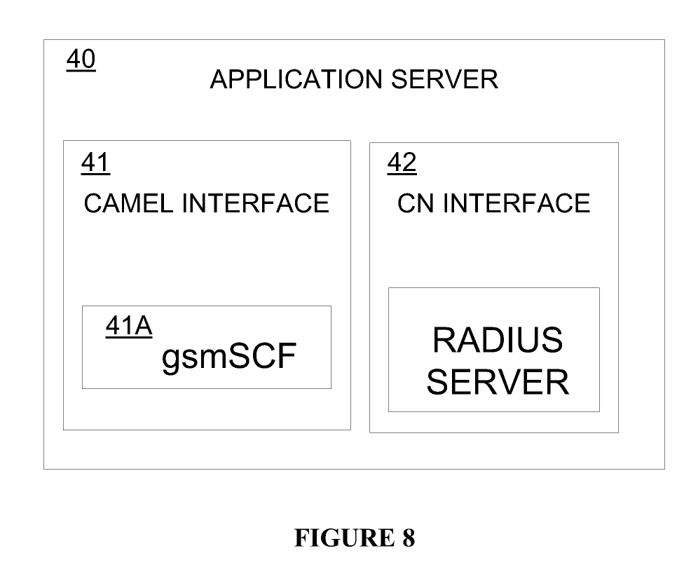

FIG. 8 illustrates an exemplary block diagram an application server 40 according to the present invention. The application server is adapted to receive from a core network 20 of a mobile advertisement system 100, a message comprising an end user identification number (e.g. MSISDN or MSI) of a user equipment and further adapted to trigger an advertisement confirmation timer (Ad timer) wherein the Ad timer is expecting to receive an advertisement display confirmation message from the user equipment before it expires. The application server 40 is further configured to request the core network 20 or a network node of the core network 20, to disconnect the user equipment upon the Ad timer expiring. The user equipment is therefore prevented from getting access to an external data network connection (e.g. the Internet). In addition, the application server may also keep or store a record (i.e. MSISDN or MSI) of the user equipment for e.g. black-listing, charging and/or customer service purposes.

As illustrated in FIG. 8, the application server 40 comprises a GSM service control function, gsmSCF 41A which is a CAMEL component. The application server 40 also comprises a CAMEL interface 41 that interfaces with the gsmSCF 41A. In addition, the application server 40 comprises a RADIUS server of a core network interface 42 (CN interface) residing in the application server 40. The protocols used to communicate with the core network nodes of the mobile advertisement system 100 are the CAMEL application part protocol (CAP) and the RADIUS protocol. It should be noted that other protocols may also be used such as the DIAMETER protocol.

The present invention, in its various embodiments, effectively detects and prevents user equipments hosting illegal or forged client applications from exploiting mobile advertisements systems and involved parties such as advertisers. It is noted that whilst embodiment of the present invention have been described in relation to a CAMEL approach and a AAA approach in a mobile advertisement system, embodiments of the proposed solution may be implemented in any advertisement system that is CAMEL enabled and/or AAA enabled.

While the invention has been described in terms of several preferred embodiments, it is contemplated that alternatives, modifications, permutations and equivalents thereof will become apparent to those skilled in the art upon reading of the specifications and study of the drawings. It is therefore intended that the following appended claims include such alternatives, modifications, permutations and equivalents as fall within the scope of the present invention

1. A mobile advertisement telecommunications system to prevent a user equipment that is hosting a forged client application, from getting access to an external data network connection, said mobile advertisement system comprising:
an application server for receiving from a core network of the mobile advertisement system, a message comprising an end user identification number of said user equipment, and triggering an advertisement confirmation timer, Ad timer, wherein said Ad timer expects to receive an advertisement display confirmation message from said user equipment before said Ad timer expires;
a core network of said mobile advertisement system, for receiving from the application server a request to disconnect said user equipment upon the Ad timer expiring, thereby preventing said user equipment from getting access to said external data network connection.

2. The mobile advertisement telecommunications system according to claim 1 wherein said core network comprises a serving GPRS support node, SGSN, and wherein said SGSN comprises a GPRS service switching function, gprsSSF, that sends said message comprising said end user identification number of the user equipment to the application server, using a CAMEL application part (CAP) protocol.

3. The mobile advertisement telecommunications system according to claim 1 further comprising a home location register (HLR) which looks up subscription details of said user equipment and requests CAMEL support from the SGSN upon verifying that said user equipment with the forged client application, is a subscriber of an advertisement service, Ad service.

4. The mobile advertisement telecommunications system according to claim 1 wherein said application server comprises a GSM service control function (gsmSCF) which is a CAMEL component that receives from said gprsSSF, the message comprising the end user identification number of the user equipment using the CAP protocol.

5. The mobile advertisement telecommunications system according to claim 4 wherein said gsmSCF relays said message to a CAMEL interface of said application server.

6. The mobile advertisement telecommunications system according to claim 5 wherein said CAMEL interface triggers said Ad timer upon receiving said message from the gsmSCF, and sends, to the gprsSSF of the SGSN said request to disconnect the user equipment upon the Ad timer expiring.

7. The mobile advertisement telecommunications system according to claim 1 wherein said core network further comprises an Authentication, Authorization and Accounting server (AAA server) and wherein said AAA server sends said message comprising the end user identification number of the user equipment to the application server using a RADIUS (or DIAMETER) protocol.

8. The mobile advertisement telecommunications system according to claim 7 wherein said application server further comprises a RADIUS server that receives from the AAA server said message comprising the end user identification number of the user equipment, and also triggers said Ad timer upon receiving said message from the AAA server.

9. The mobile advertisement telecommunications system according to claim 8 wherein said RADIUS server requests the AAA server to disconnect the user equipment upon the Ad timer expiring.

10. The mobile advertisement telecommunications system according to claim 9 wherein the AAA server sends said request to disconnect said user equipment, to a Gateway GPRS Support node (GGSN), which is connected to an SGSN of the core network.

11. The mobile advertisement telecommunications system according to claim 1 wherein the application server stores a record of the user identification number of said user equipment after the Ad timer expires.

12. The mobile advertisement telecommunications system according to claim 1 wherein said advertisement display confirmation message expected by said application server, comprises an end user identification number of a user equipment hosting an authentic client application/software and a unique identification of said advertisement display confirmation message, Message ID.

13. The mobile advertisement telecommunications system according to claim 1 wherein said end user identification number of the user equipment is a mobile subscriber integrated services digital network number (MSISDN) or an international mobile subscriber identify number (IMSI) and wherein said external data network connection is an Internet connection.

14. A method of preventing a user equipment that is hosting a forged client application from getting access to an external data network connection, said method comprising:
receiving at an application server, from a core network, a message comprising an end user identification number of said user equipment;
triggering by said application server, an advertisement confirmation timer (Ad timer), wherein said Ad timer expects to receive an advertisement display confirmation message from the user equipment before the Ad timer expires;
preventing the user equipment from getting access to the external data network connection by requesting by said application server, the core network to disconnect the user equipment upon the Ad timer expiring.

15. The method according to claim 14 further comprises, storing, by said application server a record of the end user identification number of said user equipment upon the Ad timer expiring.

16. The method according to claim 14, wherein said end user identification number of the user equipment is a mobile subscriber integrated services digital network number (MSISDN) or an international mobile subscriber identity number (IMSI) and wherein said external data network connection is an Internet connection.

17. The method according to claim 14, wherein said advertisement display confirmation message expected by said application server, comprises a user identification number of a user equipment hosting an authentic/true client application and a unique identification of said advertisement display confirmation message.

18. An application server for preventing a user equipment that is hosting a forged client application from getting access to an external data network connection, comprising:
said application server
receiving from a core network, a message comprising an end user identification number of a user equipment,
triggering an advertisement confirmation timer (Ad timer) wherein said Ad timer expects to receive an advertisement display confirmation message from the user equipment before the Ad timer expires;
said application server is requesting said core network to disconnect said user equipment upon the Ad timer expiring in said application server.

19. The application server according to claim 18 comprises a GSM service control function (gsmSCF) which is a CAMEL component that receives from said core network, the message comprising the end user identification number of the user equipment using a CAMEL application part (CAP) protocol.

20. The application server according to claim 19 further comprising a CAMEL interface that receives from said gsmSCF said message comprising the end user identification number of the user equipment and triggers said Ad timer.

21. The application server according to claim 20 wherein said CAMEL interface further requests the gsmSCF to send a request to said core network to disconnect the user equipment upon said Ad timer expiring in the CAMEL interface.

22. The application server according to claim 18 further comprises a RADIUS server of a core network interface wherein said RADIUS server receives from the said core network said message comprising the end user identification number of the user equipment and also triggers said Ad timer upon receiving said message.

23. The application server according to claim 22 wherein said RADIUS server requests said core network to disconnect the user equipment upon the Ad timer expiring.

24. The application server according to claim 18, wherein the application server stores a record of the user equipment after said Ad timer expires.

25. A core network of a mobile advertisement telecommunications system according to claim 1, for preventing a user equipment that is hosting a forged client application from getting access to an external data network connection, comprising:
said core network
sending to an application server a message comprising an end user identification number of said user equipment and
receiving from said application server a request to disconnect said user equipment hosting said forged client application upon an advertisement confirmation timer expiring in said application server thereby preventing said user equipment from getting access to said external data network connection.
